(19) United States
(12) Patent Application Publication
(10) Pub. No.: US 2010/0122179 A1
(43) Pub. Date: May 13, 2010

(54) VISUAL CABINET SYSTEM FOR DATA DISPLAY METHOD USING ITS SYSTEM

(76) Inventors: Takashi Nakamura, Tokyo (JP); Chiaki Iwasaki, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/594,738

(22) PCT Filed: Aug. 7, 2007
(86) PCT No.: PCT/JP2007/065463

§ 371 Date: Oct. 5, 2009

(30) Foreign Application Priority Data
Apr. 26, 2007 (JP) 2007-117734

(51) Int. Cl. H04L 9/32; G06F 15/16; G06F 3/048

(52) U.S. Cl. 715/741

(57) ABSTRACT

A client-oriented system whereby a user can visually comprehend an itemized outline to immediately confirm the contents of data is provided. This system includes a WEB server and a database server. The WEB server includes a user browsing site, an image acquisition site and a screen image batch processor that accesses the data table of a database for a predetermined period of time and requests the image acquisition site to create a screen image associated with the new/updated data and obtains the screen image if there is new data and updated data. The user browsing site also includes a WEB screen creation unit that, when an authenticated user requests to display a predetermined screen associated with one of the data IDs included in user and data tables, creates the screen by providing a link for the obtained screen image for transition to another screen corresponding to the screen image.

### TECHNICAL FIELD

The present invention relates to a data visual cabinet system and a data display method employing this system.

### BACKGROUND ART

When a client employs a client-oriented system to browse desired data on the Internet and to confirm details of the data content, generally, the client takes a method that permits a user to click on menu information represented using text characters or simple images to acquire various items from a database, which correspond to selected menu items, to open a WEB page on which these items are presented and to confirm an itemized list of the data contents.

There is also a well known site whereat electronic IR (Investor Relations) information from contributing companies are transmitted to a specific company, such that the received IR information are automatically arranged in a web page for the contributing companies on the homepage of the specific company to be presented to a person (investor) who browses the site.

In the above described site, a linking system has been disclosed with which, when a cursor is moved to an icon for an individual item at a company site displayed on an investor's screen, the investor can find when data for each item in the company site was read, and can identify whether the latest site updated by the company was referred to (see, for example, patent document 1).

Patent Document 1: Japanese Patent Laid-Open No. 2003-316809

### DISCLOSURE OF THE INVENTION

However, even though such a linking system is employed, a client still must depend on menu information represented by text characters or simple images to open a WEB page on which the contents of various types of data are presented, and confirm itemized data until desired information is found. Therefore, this is very complicated process for a client who uses this system.

Thus, taking the above described shortcoming into account, one objective of the present invention is to provide a data visual cabinet system that enables a client to visually comprehend an itemized outline of data contents, using a client-oriented system via the Internet, and to immediately confirm the itemized data contents, and a data display method that uses this system.

To achieve this objective, according to a first aspect of the present invention, this visual cabinet system comprises: a WEB server which includes a user browsing site that is accessible from a user terminal via the Internet; and a database server,

wherein the database server includes
a master user table having a user ID, a password and a subscriber account for a user permitted to access the user browsing site via the Internet: and
a data table having a data set which includes a data ID associated with the subscriber account;

wherein the WEB server includes
an image acquisition site which is a mirror site for the user browsing site; and
a screen image batch processor for accessing the data table every predetermined period of time, and if new data and updated data are present in the data table each time, requesting the image acquisition site to create one or more HTML screens associated with all of the new and the updated data, and obtaining images of the one or more HTML screens;

wherein the user browsing site includes
a user authentication unit for comparing a user ID and a password that are received from the user terminal via the Internet with the user ID and the password stored in the user master table, and for determining whether access to the user browsing site may be approved,
a screen image storage unit for storing images for the one or more HTML screens obtained by the screen image batch processor, and
a WEB screen creation unit for, when the authenticated user terminal requests to display a predetermined HTML screen that has been associated with the subscriber account and one of data IDs included in the data table, creating the predetermined HTML screen by providing a link for transition to an HTML screen or screens corresponding to the image of one or more HTML screens for an image of the one or more screens associated with the subscriber account and the data ID and that are stored in the screen image storage unit; and

wherein the latest information, which is associated with the subscriber account and the data ID, is displayed on the one or more HTML screens.

Furthermore, according to the first aspect of the present invention, the user browsing site may include:

a screen image creation unit for, when the authenticated user terminal requests to display the predetermined HTML screen and, when the image of the one or more HTML screens associated with the subscriber account and the data ID have not been stored in the screen image storage unit, requesting the image acquisition site to acquire the one or more HTML screens associated with the subscriber account and the data ID and to store the image for the one or more HTML screens in the screen image storage unit.

Further, according to the first aspect of the present invention, the database server may comprise a display pattern master table that includes, for each subscriber account,

information related to whether the image for the one or more HTML screens obtained by the screen image batch processor, should be displayed on the predetermined HTML screen, and

a template which defines layouts for the image of the one or more HTML screens.

According to a second aspect of the present invention, a data display method employing this visual data cabinet system that includes:

a WEB server which includes a user browsing site accessible from a user terminal via the Internet, a screen acquisition site that is a mirror site for the user browsing site, and a screen image batch processor; and

a database server which includes a user master table having a user ID, a password and a subscriber account for a user permitted to access to the user browsing site via the Internet, and a data table having a data set which includes a data ID in association with the subscriber account, wherein the user browsing site includes a screen image storage unit and a WEB screen creation unit

wherein the screen image batch processor accesses the data table every predetermined period of time, and if new data and updated data are present in the data table, the screen image batch processor requests the image acquisition site to create one or more HTML screens associated with all of the new and the updated data, and obtains images for the one or more HTML screens to be stored in the screen image storage unit;

wherein the user authentication unit compares a user ID and a password that are received from the user terminal via the Internet with the user ID and the password stored in the user master table, and determines whether access to the user browsing site may be approved; and

wherein, when the authenticated user terminal requests to display a predetermined HTML screen associated with the subscriber account and one of data IDs included in the data table, the WEB screen creation unit creates the predetermined HTML screen by providing a link for transition to an HTML screen or screens corresponding to the image of one or more HTML screens for an image of the one or more screens that are associated with the subscriber account and the data ID and stored in the screen image storage unit.

Furthermore, according to the second aspect of the present invention, the user browsing site may further include a screen image creation unit,

wherein, when the authenticated user terminal requests to display the predetermined HTML screen and, when the image of the one or more HTML screens associated with the subscriber account and the data ID have not been stored in the screen image storage unit, the screen image creation unit requests the image acquisition site to acquire the one or more HTML screens associated with the subscriber account and the data ID and to store the image for the one or more HTML screens in the screen image storage unit.

Also, according to the second aspect of the present invention, the database server may have a display pattern master table that includes, for each subscriber account,

information related to whether the image for the one or more HTML screens, obtained by the screen image batch processor should be displayed on the predetermined HTML screen, and

a template according to which layouts for the image of the one or more HTML screens are defined.

According to the present invention, the outline of itemized data contents can be visually comprehended via the Internet to immediately confirm the details of the data contents.

In addition, according to the present invention, screen images stored for user types can be displayed using the type and layout that match the needs of each user.

### BRIEF DESCRIPTION OF THE DRAWINGS

FIG. 1 is a block diagram illustrating the configuration of a visual cabinet system according to one embodiment of the present invention;

FIG. 2 is a block diagram illustrating an example hardware arrangement for a server computer that is included in the visual cabinet system according to this embodiment;

FIG. 3 is a block diagram illustrating a more detailed arrangement of a WEB server that is included in the visual cabinet system according to this embodiment;

FIG. 4 is an explanatory diagram of a screen image storage unit for the WEB server included in the visual cabinet system according to this embodiment;

FIG. 5 is an explanatory diagram of a user master table in the database of a database server that is included in the visual cabinet system according to this embodiment;

FIG. 6 is an explanatory diagram of a data table in the database of the database server that is included in the visual cabinet system according to this embodiment;

FIG. 7 is an explanatory diagram of a display pattern master table in the database of the database server that is included in the visual cabinet system according to this embodiment;

FIG. 8 is a flowchart showing the processing performed by the image acquisition batch processor of the visual cabinet system according to this embodiment;

FIG. 9 is a flowchart showing the process for creating a cabinet itemization screen provided by the visual cabinet system according to this embodiment;

FIG. 10 is a flowchart showing the processing performed by the cabinet screen image creation unit of the visual cabinet system according to this embodiment;

FIG. 11 is a diagram showing an example user ID/password input screen provided by the visual cabinet system according to this embodiment;

FIG. 12 is a diagram showing an example menu screen provided by the visual cabinet system according to this embodiment;

FIG. 13 is a diagram showing an example cabinet list screen provided by the visual cabinet system according to this embodiment;

FIG. 14 is a diagram showing another example cabinet list screen provided by the visual cabinet system according to this embodiment;

FIG. 15 is a diagram showing an additional example cabinet list screen provided by the visual cabinet system according to this embodiment;

FIG. 16 is a diagram showing an example itemized cabinet screen provided by the visual cabinet system according to this embodiment;

FIG. 17 is a diagram showing another example itemized cabinet screen provided by the visual cabinet system according to this embodiment;

FIG. 18 is a diagram showing an additional example itemized cabinet screen provided by the visual cabinet system according to this embodiment;

FIG. 19 is a diagram showing an example attached file display screen provided by the visual cabinet system according to this embodiment;

FIG. 20 is a diagram showing one more example itemized cabinet screen provided by the visual cabinet system according to this embodiment; and

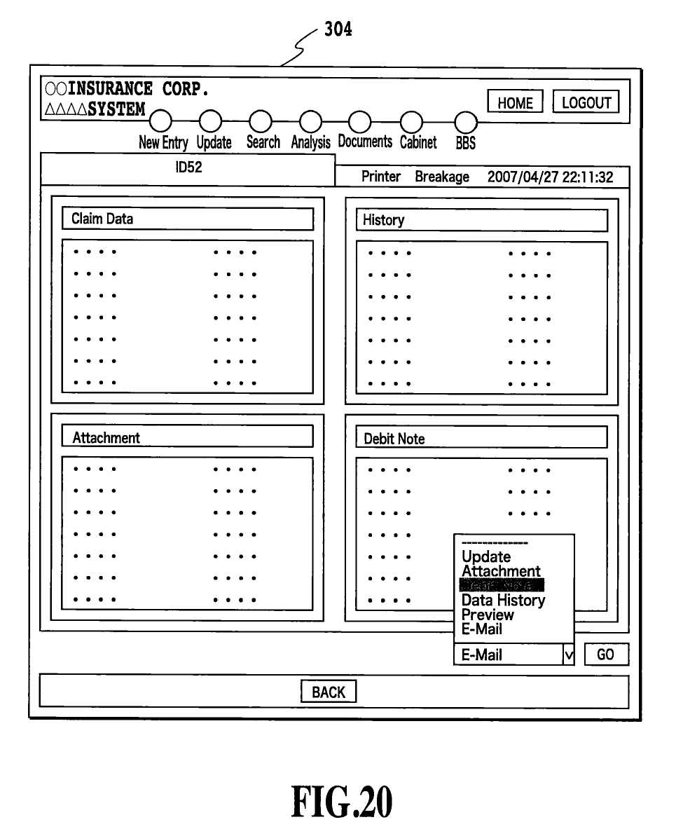

FIG. 21 is a diagram showing an example history display screen for the issuance of insurance claim forms.

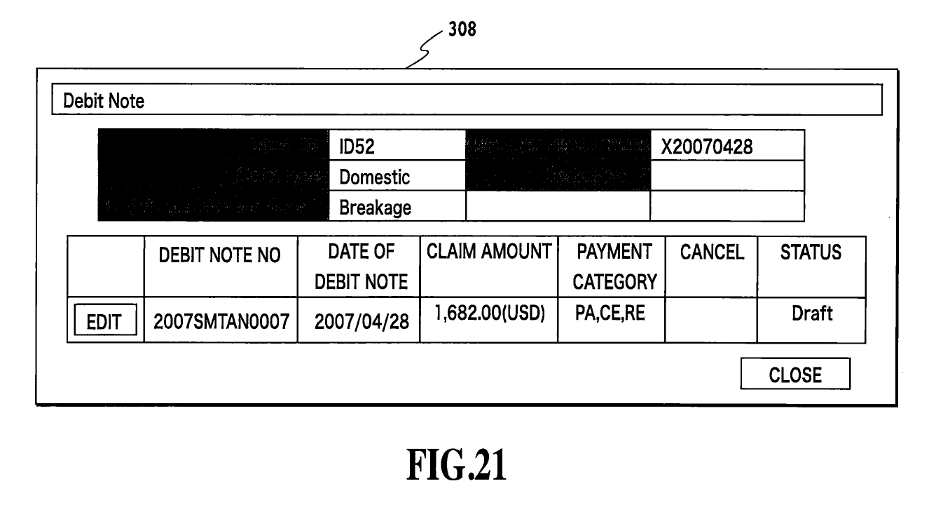

### BEST EMBODIMENT FOR CARRYING OUT THE INVENTION

Embodiments of the present invention will now be described in detail with reference to figures. In the individual drawings referred to herein, the same reference numerals are provided for portions having the same functions. Further, although the insurance business is employed as an example for the following description, the present invention can be applied not only for the insurance business but also for various other businesses such as projects, transactions and the like.

(System Configuration)

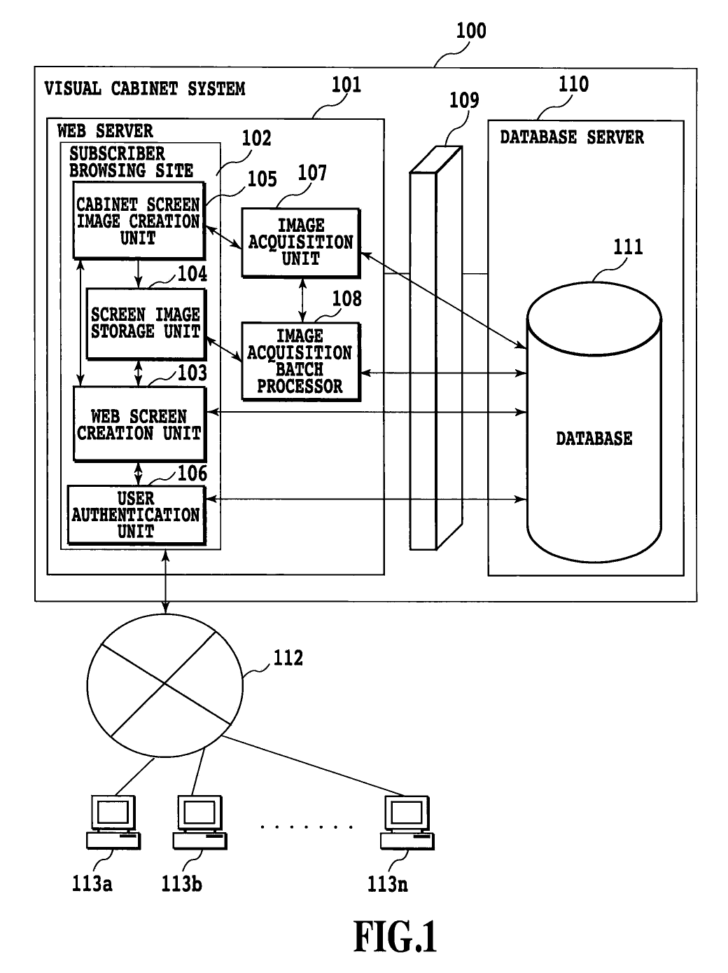

FIG. 1 is a block diagram illustrating the configuration of a visual cabinet system 100 according to the embodiment of the present invention. The visual cabinet system 100 includes: a WEB server 101, which is a node using the WWW (World Wide Web); a database server 110, which stores a set of claim data and user (subscriber) information related to the insurance business as a database 111; and a firewall 109, which prevents external, unauthorized accesses. In this embodiment, it is assumed that claim data are data to be stored in the database. However, in the present invention, data to be stored are not limited to such data.

The WEB server 101 includes: a subscriber browsing site 102, where a user employs a user terminal 113a to 113n, such as a personal computer (PC), to access an HTML screen that has been output as a result of processing performed for various data via the Internet 112; an image acquisition site 107 that is a WEB site for acquiring the latest HTML screen image (hereinafter also called a cabinet screen image or a screen image) to be displayed on the output screens of the user terminals 113a to 113n; and an image acquisition batch processor 108 that, requests an HTML screen from the image acquisition site 107 every predetermined period of time, creates a cabinet screen image to be displayed on the output screens of the user terminals 113a to 113n, and stores the cabinet screen image in a screen image storage unit 104 at the subscriber browsing site 102, which will be described later.

The subscriber browsing site 102 includes: a user authentication unit 106, which authenticates an access request by a user for a subscriber browsing site; a WEB screen creation unit 103 which describes the HTML (HyperText Markup Language) code for making the user terminals 113a to 113n display an HTML screen that includes a user ID/password input screen, etc.; the screen image storage unit 104 for storing a cabinet screen image; and a cabinet screen image creation unit 105, which requests an HTML screen from the image acquisition site 107, creates a cabinet screen image to be displayed on the output screens of the user terminals 113a to 113n, and makes the screen image storage unit 104 store the cabinet screen image.

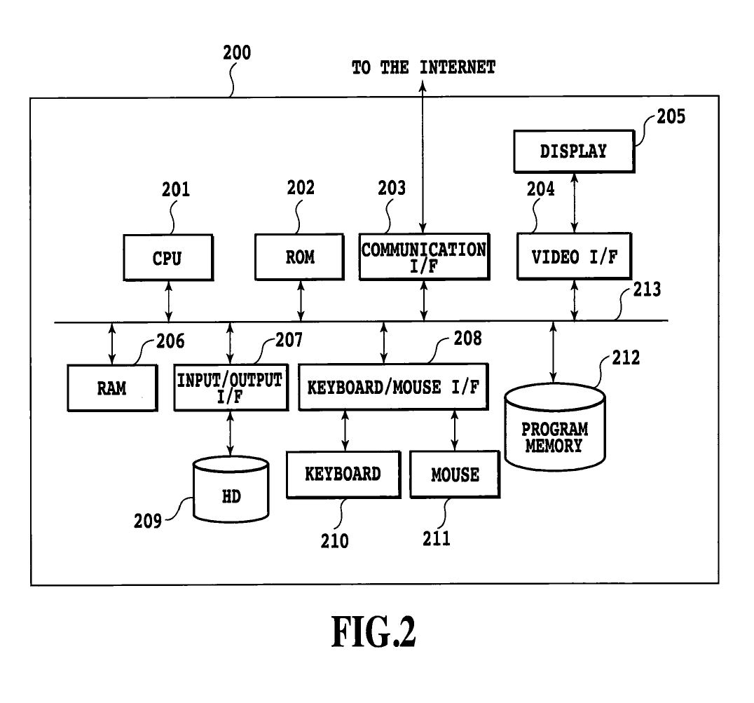

FIG. 2 is a block diagram illustrating one example hardware arrangement of a server computer that is included in the visual cabinet system 100 according to this embodiment. The server computer having the arrangement shown in FIG. 2 is employed both for the WEB server 101 and the database server 111 in FIG. 1. Each of the WEB server 101 and the database server 111 may be composed of a plurality of server computers. Furthermore, the WEB server 101 may be distributed to a server that has a function to provide an operating logic provided by the visual cabinet system 100, and to a server that has a function whereby data processed by the operating logic is presented to a user as an output screen.

In the server computer 200, a CPU (Central Processing Unit) 201 which controls the entire system, a ROM (Read Only Memory) 202 which stores, for example, a system program for controlling the entire system, and a RAM (Random Access Memory) 206 which is a temporary storage area, are interconnected by a bus 213. Further, a program memory 212 which stores a program that executes the processing related to the present invention, a keyboard/mouse interface (I/F) 208 to which a keyboard 210 and a mouse 211 are connected, a video I/F 204 which is connected to a display device 205, a communication I/F 203 such as a modem that communicates with the Internet, and an input/output I/F 207 which is connected to a hard disk 209, are connected to the bus 213.

Each process related to this embodiment is performed when the CPU 201 executes a program code, read from the program memory 212 which stores the program code of a program for realizing each process, which will be described later.

The Web server 101 and the database server 110 are program modules designed to provide individual functions. For example, a communication program that communicates with the user terminals 113a to 113n, a WEB server program that transmits an input screen, etc., in accordance with HTTP (HyperText Transfer Protocol), and a program that displays an input screen, etc., on a client browser are employed as means for displaying screens on the user terminals 113a to 113n. An example program that displays the input screen, etc., can be an ASP (Active Server Pages) file provided by an IIS (Internet Information Server) which is a Web server on Microsoft Windows (Registered Trademark). Information processing, such as database searching based on information received via a WEB page, can also be performed using an ASP file.

Furthermore, the process for managing the database 111 by the database server 110, and the process for accessing the database 111 by the WEB server 101 are respectively performed by well known application programs for a database server and for a database client.

These programs are written in a markup language, such as HTML, in addition to a high-level procedural programming language, an object-oriented programming language, an assembly language or a machine language. In such a method, the program memory 212 composed by a hard disk, a magneto-optical disk, an optical disk, a CD-ROM, a CD-R, a magnetic tape, a nonvolatile memory card, a ROM, etc., serves as a computer-readable recording medium.

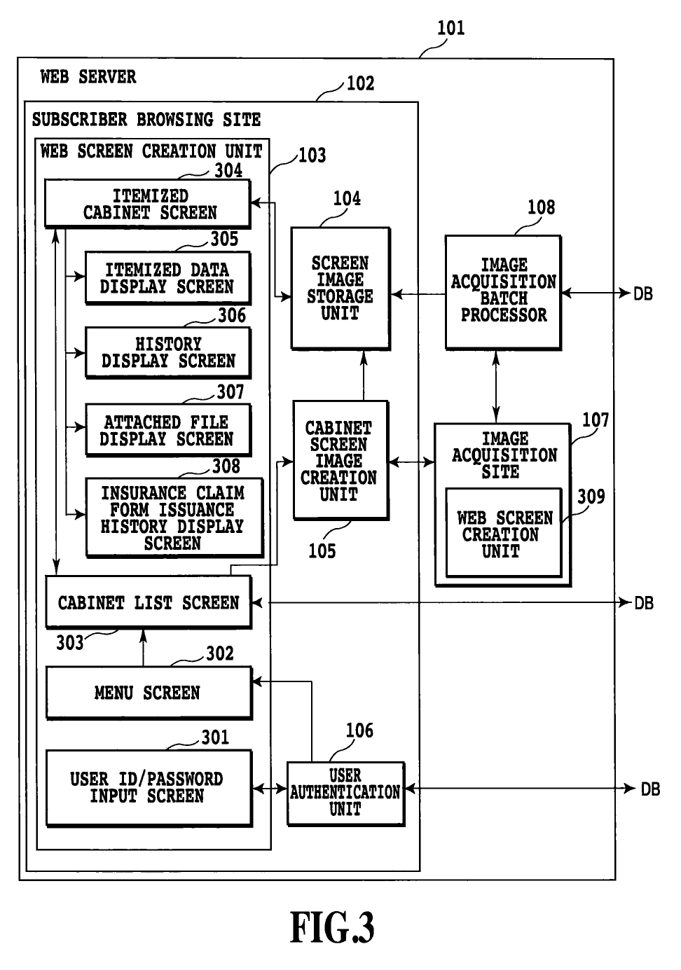

FIG. 3 is a block diagram illustrating a more detailed constitution of the WEB server 101 included in the visual cabinet system 100 according to this embodiment.

The WEB screen creation unit 103 of the subscriber browsing site 102 can create a static HTML screen presented by an HTML file, or can create a dynamic HTML screen using, for example, the above described ASP file. The WEB screen creation unit 103 describes the HTML file for providing a user ID/password input screen 301 which is displayed on the output screens of the user terminals 113a to 113n so that users can perform the authentication process; a menu screen 302 for transition to a screen for providing various services; a cabinet list screen 303 which displays a list of claim data; and an itemized cabinet screen 304 which displays various cabinet screen images related to one set of claim data. The WEB screen creation unit 103 also describes the HTML file to create an itemized data display screen 305 which is displayed on the output screens of the user terminals 113a to 113n to present itemization related to one set of claim data; a history display screen 306 which presents historical information related to one set of claim data; an attached file display screen 307 for displaying an image file, etc., for a product and others related to one set of claim data; and an insurance claim form issuance history display screen 308 which displays the history of an insurance claim form that was issued for one set of claim data. In this embodiment, the WEB screen creation unit 103 creates these HTML screens. However, the present invention is not limited to the creation of these HTML screens.

The user authentication unit 106 of the subscriber browsing site 102 matches user IDs and passwords stored in the database 111 of the database server 110 with ID and password entries transmitted via the user ID/password input screens at the user terminals 113a to 113n to determine, thereby, whether users are authenticated or not. If the user authentication unit 106 certifies that the users are authenticated, the menu screen 302 created by the WEB screen creation unit 103 is displayed on the output screens of the user terminals 113a to 113n.

The screen image storage unit 104 of the subscriber browsing site 102 stores for individual subscriber accounts screen image files that are created either by the cabinet screen image creation unit 105, which will be described later, or the image batch processor 108, which will also be described later.

The cabinet screen image creation unit 105 of the subscriber browsing site 102 permits the WEB screen creation unit 309 of the image acquisition site 107, which will be described later, to describe HTML file for creating HTML screens, so that the cabinet screen image creation unit 105 can access the image acquisition site 107 and obtain all the HTML screens (the above described four HTML screens 305 to 308 in this embodiment) related to claim data, which is selected by a user who has logged in and is employed by the visual cabinet system 100. The cabinet screen image creation unit 105 then employs well known capture software to create image files for the obtained HTML screens, and stores the screen image files in individual subscriber account folders (directories) in the screen image storage unit 104 of the subscriber browsing site 102.

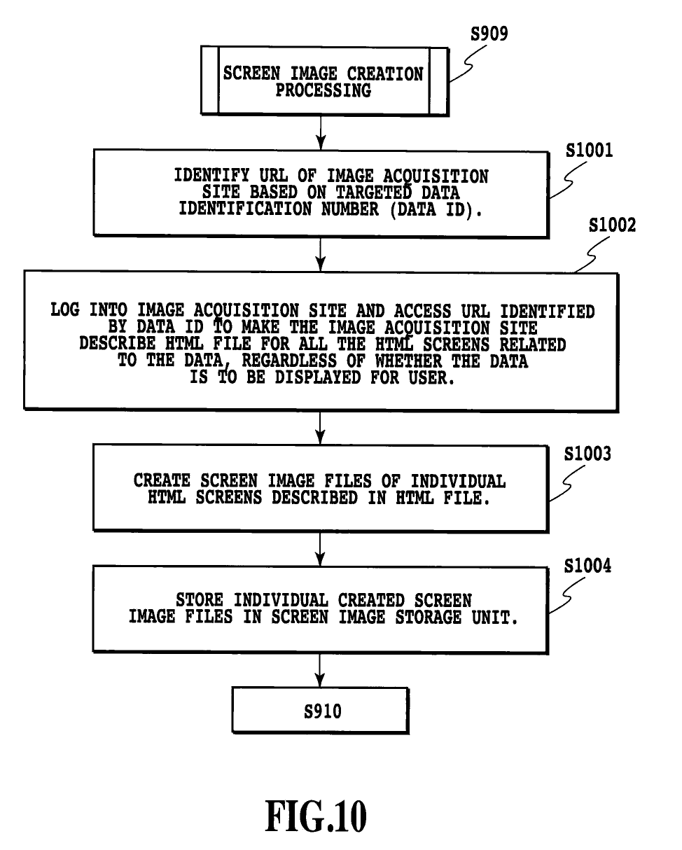

Here, since the processing by the image acquisition batch processor 108 that will be described later is performed each time a predetermined time period has passed, screen images related to claim data selected by a user may not be present in the screen image storage unit 104. For this reason, if screen images that are related to claim data selected by a user are not found in the screen image storage unit 104, the cabinet screen image creation unit 105 must create those screen images when claim data is selected by the user. The process performed by the cabinet screen image creation unit 105 will be described later with reference to FIG. 10. Although an image file for an HTML screen is a gif file in this embodiment, an image file such as a jpeg file or a png file may also be employed.

The image acquisition site 107 includes the WEB screen creation unit 309 similar to the WEB screen creation unit 103 of the subscriber browsing site 102. The WEB screen creation unit 309 describes HTML file for the same HTML screens as the itemized data display screen 305, the history display screen 306, the attached file display screen 307 and the insurance claim form issuance history display screen 308 of the subscriber browsing site 102. The image acquisition site 107 is a mirror site of the subscriber browsing site 102, and can be accessed only inside the visual cabinet system 100, and an external access including an access by a user (subscriber) is not allowed.

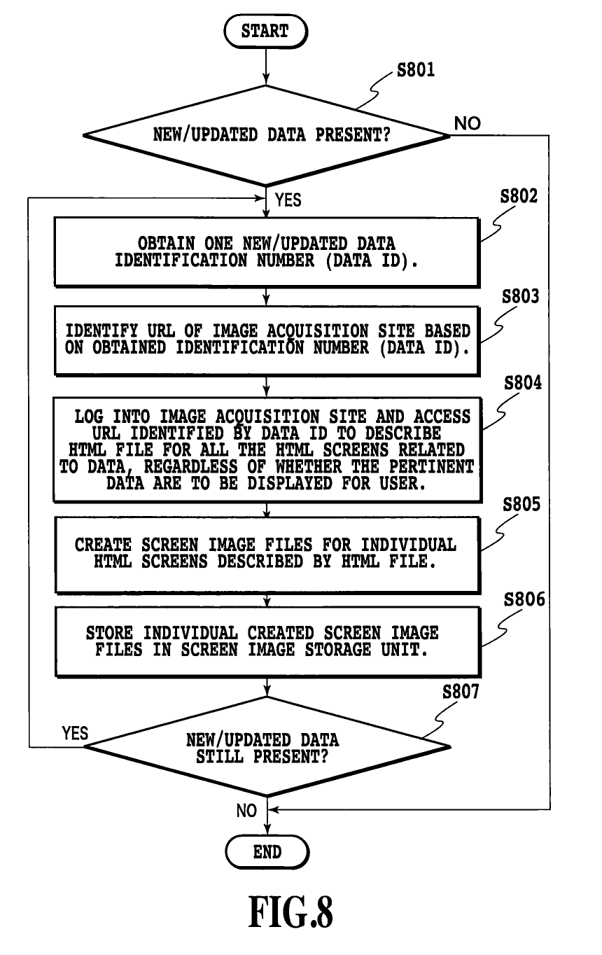

The image acquisition batch processor 108 permits the WEB screen creation unit 309 of the image acquisition site 107 to describe the HTML file for HTML screens so that the image acquisition batch processor 108 can access claim data stored in the data base of the database server 110 and obtain all the HTML screens related to new and updated claim data stored in the database 111. The image acquisition batch processor 108 creates image files for the obtained HTML screens using well known capture software and stores the screen image files in the individual subscriber account folders (directories) in the screen image storage unit 104 of the subscriber browsing site 102. The processing performed by the image acquisition batch processor 108 will be described later with reference to FIG. 8. As described above, although an image file for an HTML screen is a gif file in this embodiment, another image file may also be employed. This batch processing is performed every ten minutes. However, the processing may be performed every five minutes or every fifteen minutes.

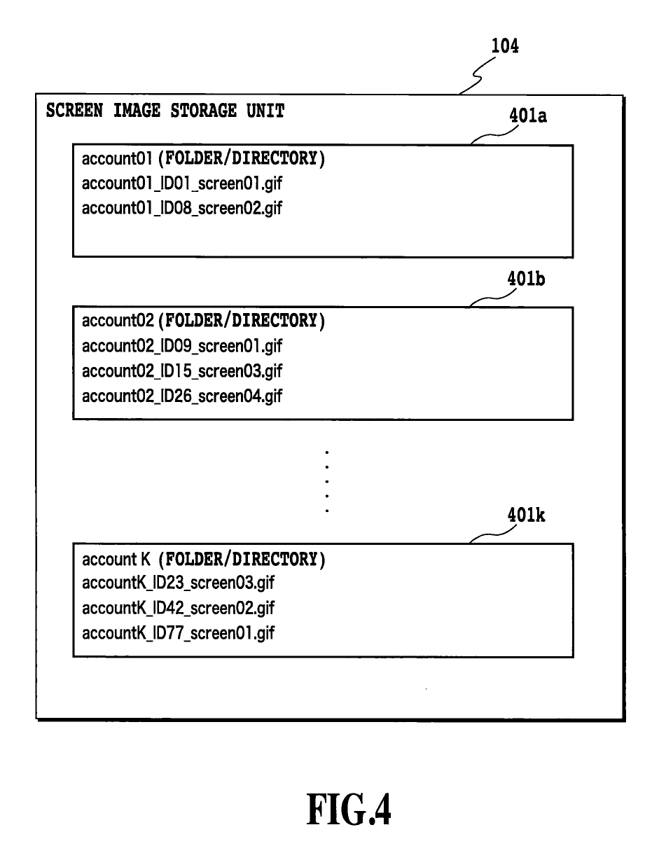

FIG. 4 is an explanatory diagram for the screen image storage unit 104 of the WEB server 101 included in the visual cabinet system 100 according to this embodiment.

As illustrated, folders (directories) 401a to 401k for the individual subscriber accounts are present in the screen image storage unit 104. For example, the folder (directory) 401a is for subscriber account “account01”, the folder (directory) 401b is for subscriber account “account02”, and the folder (directory) 401k is for subscriber account “acountK”.

A screen image file which has a unique file name that consists of a subscriber account name, a data identification number (data ID) and a screen number, is stored in each folder (directory). In this embodiment, for example, files having unique names, such as “account01_ID01_screen01.gif” and “account01_ID08_screen02.gif”, are stored in the folder (directory) 401a for subscriber account “account01”. This naming rule for filenames is merely an example, and an arbitrary naming rule may be employed so long as a file name is uniquely identified using a subscriber account name, a data identification number (data ID) and a screen number. In addition, in this embodiment, to identify the screens, the itemized data display screen 305 is “screen01”, the history display screen 306 is “screen02”, the attached file display screen 307 is “screen03”, and the insurance claim form issuance history display screen 308 is “screen04”.

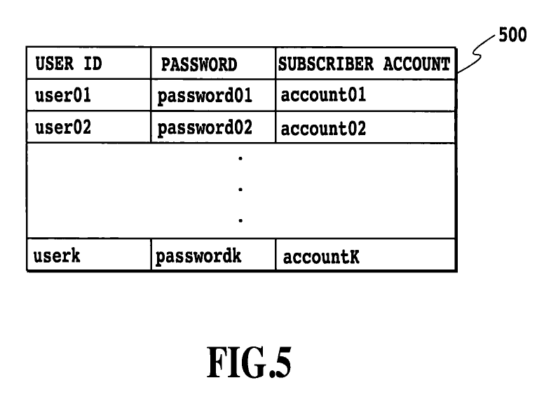

FIG. 5 is an explanatory diagram for a user master table 500 in the database 111 of the database server 110 included in the visual cabinet system 100 according to this embodiment.

The user master table 500 is used for login authentication, and is composed of user ID fields, password fields and subscriber account fields.

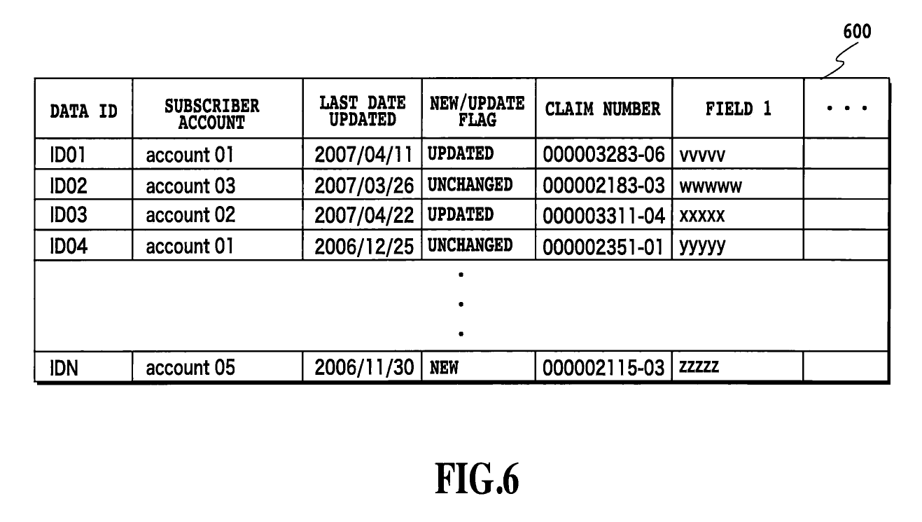

FIG. 6 is an explanatory diagram of a data table 600 in the database 111 of the database server 110 included in the visual cabinet system 100 according to this embodiment.

The data table 600 is composed of data ID fields, subscriber account fields, last date updated fields, new/update flag fields, claim number fields and an arbitrary number of other fields.

The data ID field is a field for uniquely defining claim data. The subscriber account field is an identity field for a subscriber account related to claim data. The last date updated field is a field indicating the last date claim data was updated. The new/update flag field is a field indicating that claim data are new data that was added (in FIG. 6, indicated as new), updated data (indicated as updated in FIG. 6), or data that is neither new nor updated (indicated as unchanged in FIG. 6). The claim number is a field that indicates a data number uniquely allocated in accordance with a claim type by an insurance company that provides this system.

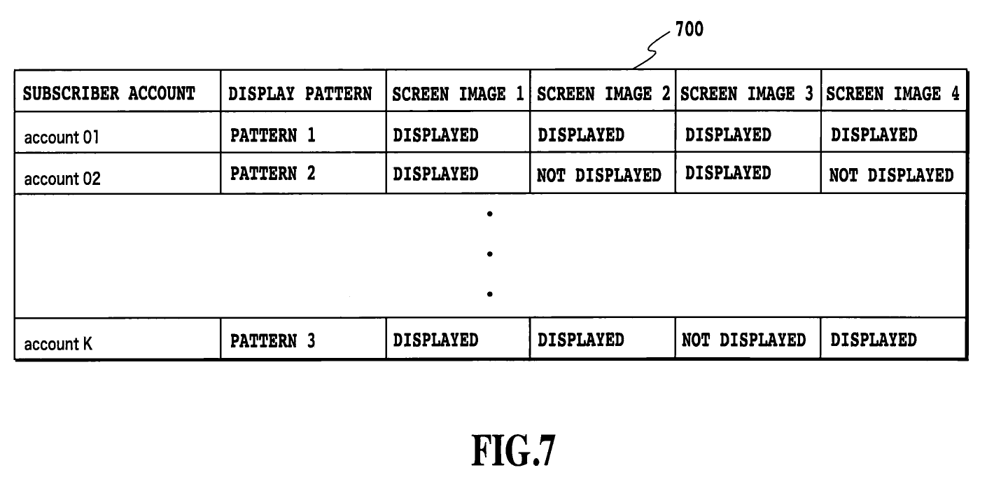

FIG. 7 is an explanatory diagram of a display pattern master table 700 in the database 111 of the database server 110 included in the visual cabinet system 100 according to this embodiment.

The display pattern master table 700 includes subscriber account fields, display pattern fields, screen image 1 fields, screen image 2 fields, screen image 3 fields and screen image 4 fields. The display pattern indicates a template which designates in advance a design for the itemized cabinet screen 304 or a layout for each screen image to be displayed on the screen 304. This template is stored as a file at a predetermined location in the screen image storage unit 104, for example.

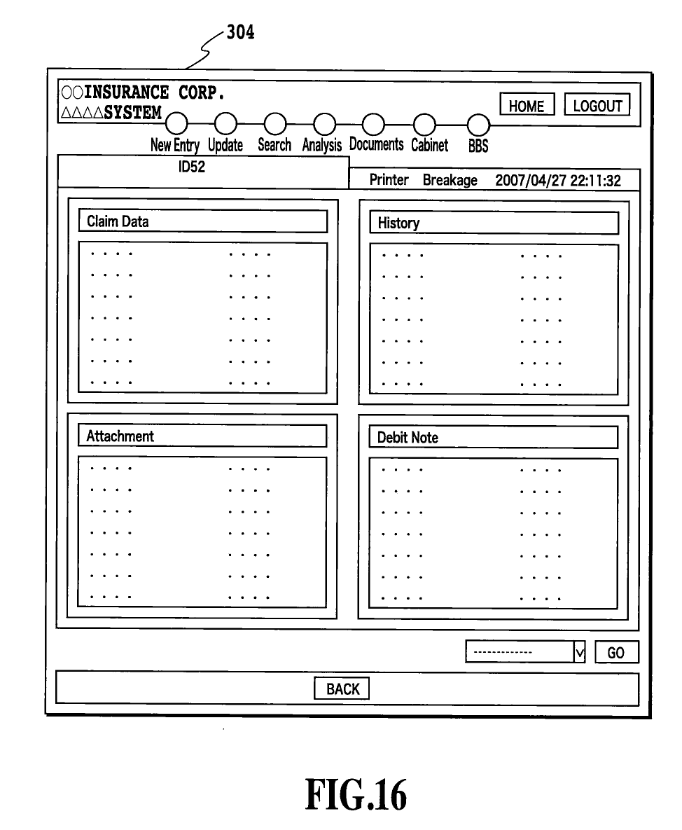

In addition, in this embodiment, the screen image 1 field represents an itemized data display screen image, the screen image 2 field represents a history display screen image, the screen image 3 field represents an attached file display screen image, and the screen image 4 field represents an insurance claim form issuance history display screen image. These four fields represent whether each of the screen images 1 to 4 is displayed on the itemized cabinet screen 304 or not. These four screen images described above are employed in this embodiment. However, the present invention is not limited to these screen images, and an arbitrary number of screen images and arbitrary layouts can be employed (see, for example, FIGS. 16 to 18).

Furthermore, a user can change a display pattern and the display/non-display of the screen images 1 to 4 and can select an itemized cabinet screen 304 dedicated to the user via a WEB screen (not shown).

(Explanation of an Operation)

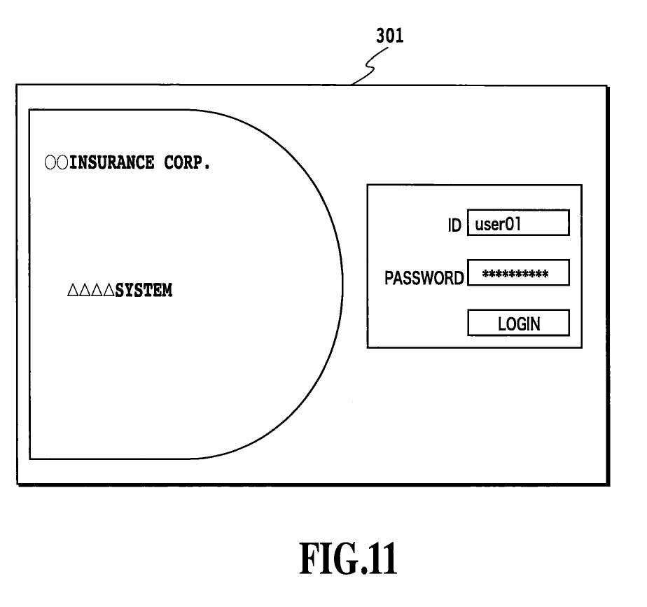

The operation of the visual cabinet system of this embodiment having the above described configuration will now be described with reference to various example WEB screens in FIGS. 11 to 19 provided by the visual cabinet system according to this embodiment.

FIG. 8 is a flowchart showing the processing performed by the image acquisition batch processor 108 of the visual cabinet system 100 according to this embodiment.

First, the database server 110 is accessed and the data table 600 of the database 111 is searched to determine whether new and updated data are present (S801). If new and updated data are not present, the processing is terminated.

If new data and updated data are present at S801, an identification number (a data ID) for either the new or the updated data is obtained (S802). Since each HTML file is described for URL that includes a data ID at the image acquisition site 107, the URL of the image acquisition site 107 is specified based on the obtained identification number (data ID) (S803).

The image acquisition site 107 is then logged in, the URL specified by the obtained identification number (data ID) is accessed, and regardless of whether data are to be displayed for the user or not, HTML file for all the HTML screens (four in this embodiment) related to the data are described by the WEB screen creation unit 309 (S804). At the time of a login to the image acquisition site 107, authentication is performed for security purposes. However, since an ID and a password required for authentication are set for a program that performs this processing, disapproval of the login does not occur as a result of the authentication process.

Next, each image file (gif files in this embodiment) for the HTML screens represented by HTML file described at S804, are created using well known capture software (S805). The file names of these screen images are determined so that each can be uniquely identified based on a subscriber account, a data identification number (a data ID) and a screen number. Then, the created screen image files are stored in the individual subscriber account folders (directories) of the screen image storage unit 104 (S806). If the same file is present among files created previously, the file is overwritten with a new file, and the latest screen image is always stored in the screen image storage unit 104.

Then, the database server 110 is accessed, and in the data table 500 of the database 111, the new/updated flag field for the pertinent data is changed to “unchanged”, and thereafter, a search is performed to determine whether new data and updated data are still present (S807). If there is neither new data nor updated data, the processing is terminated. On the other hand, if new data and updated data are present, the processing returns to S802, and the above steps are repeated.

Here, a priority field may be provided in the data table 600 in FIG. 6, and new data and updated data may be processed in the descending order of the priority levels provided in the priority field. This process becomes especially effective when data volume is increased by using the priority field.

In this embodiment, the image acquisition batch processing is performed every ten minutes. However, this processing may also be performed every five minutes, or every fifteen minutes.

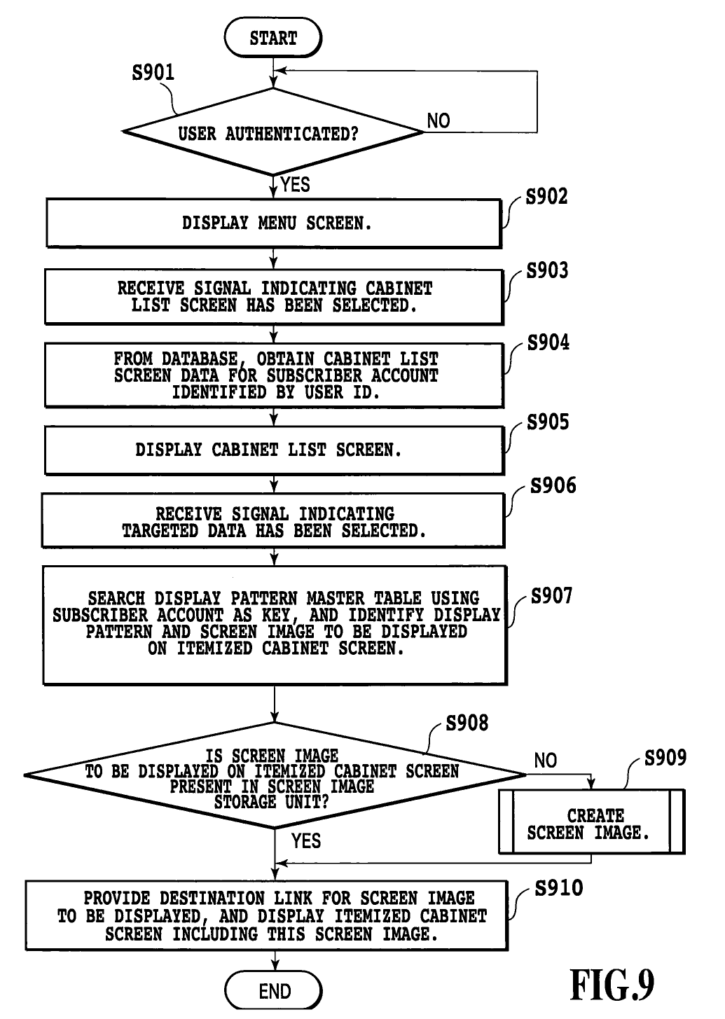

Next, with reference to FIG. 9, an explanation will be described for the processing performed to create the itemized cabinet screen 304 provided by the visual cabinet system 100 according to this embodiment.

FIG. 9 is a flowchart showing the processing for creating the itemized cabinet screen 304 provided by the visual cabinet system 100 according to this embodiment.

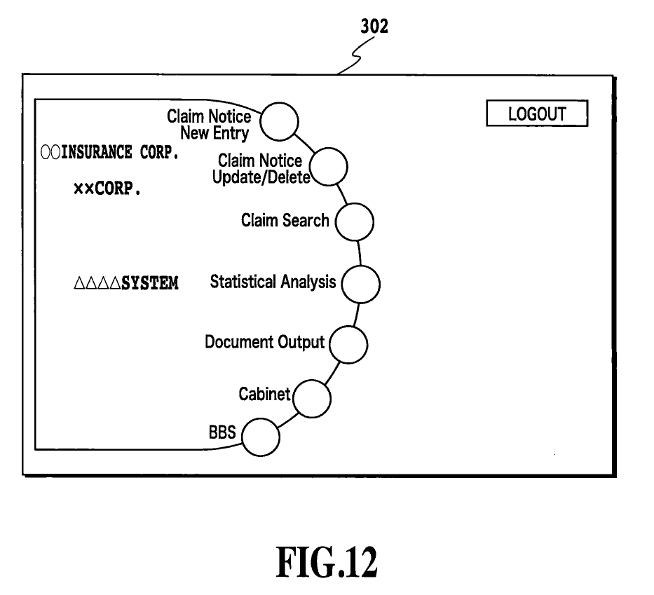

First, the user authentication unit 106 compares a user ID and password entry transmitted from a user via the user ID/password input screen 301 as shown in FIG. 11 (S901) with a user ID and a password stored in the user master table 500 of the database 111. If the user IDs and the passwords do not match, the process at S901 is repeated. On the other hand, when the user IDs and passwords match (for example, if the ID “user01” and the PASSWORD “password01” are entered and “LOGIN” is clicked on), the menu screen 302 (see FIG. 12) created for a user is displayed on the output screen of the user terminal (S902).

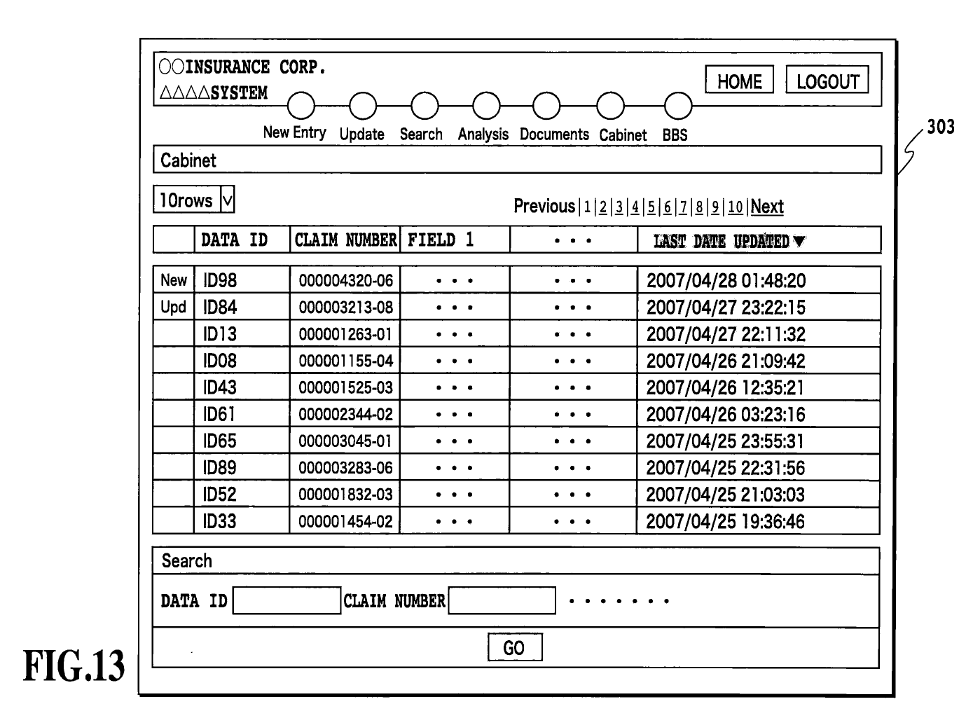

Then, when the WEB server 101 has received a signal indicating that the user selected a cabinet list screen by clicking on the Cabinet button in FIG. 12 (S903), the WEB screen creation unit 103 obtains data for the cabinet list screen 303 of a subscriber account that is designated based on the user ID from the data table 600 of the database 111 (S904), and displays the cabinet list screen 303 on the output screen of the user terminal as shown in FIG. 13 (S905). In this embodiment, default data are displayed for every ten cases in descending order according to the last date updated (see FIG. 13).

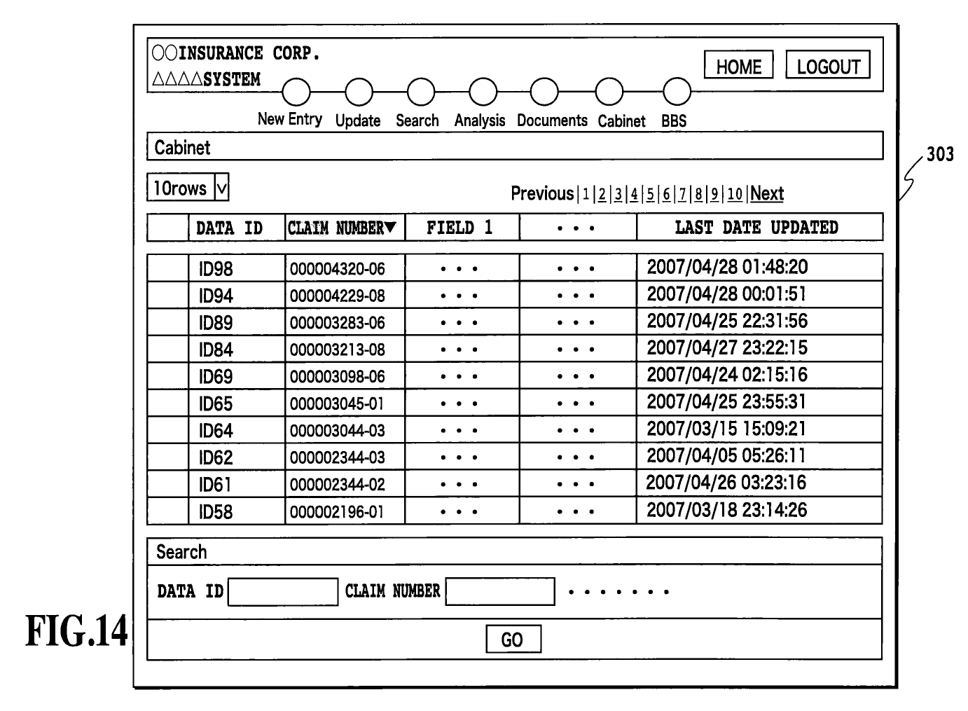

Also, when an entry such as a data ID or a claim number on the cabinet list screen 303 is clicked on, data are rearranged in the descending order based on the selected entry. For example, FIG. 14 shows the cabinet list screen 303 in which the claim number was clicked on.

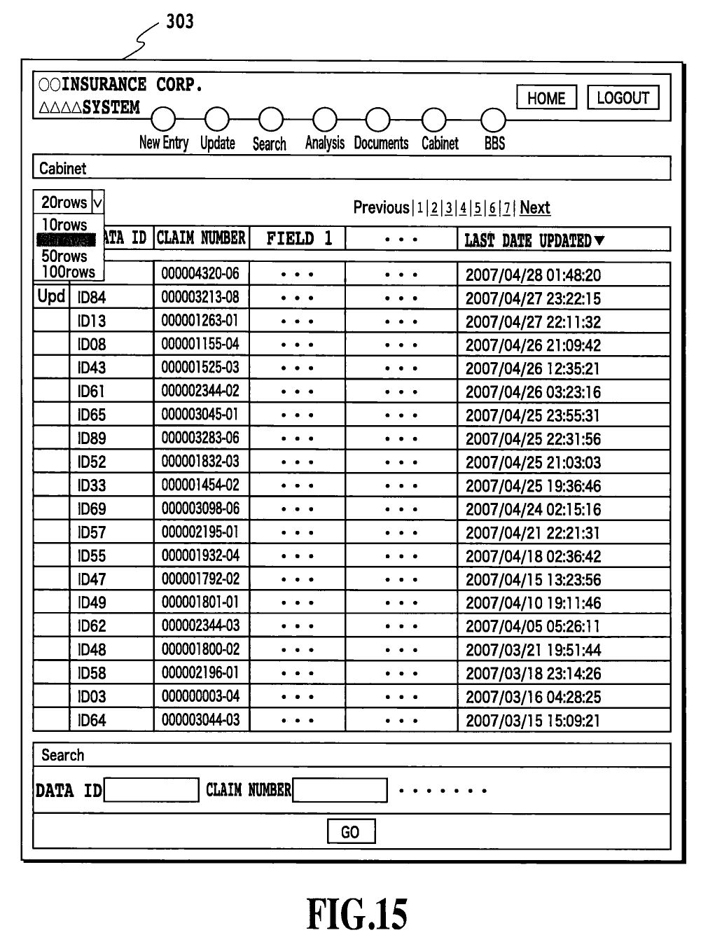

Furthermore, when an upper left pull-down button is selected on the cabinet list screen 303 in FIG. 13 or 14, the number of cases to be displayed on the cabinet list screen 303 is changed. For example, FIG. 15 shows the cabinet list screen 303 after the number of data cases was changed from ten to twenty for the cabinet list screen 303 in FIG. 13.

Returning to FIG. 9, assume that the user either clicked on the data ID portion of targeted data on the cabinet list screen 303 in FIGS. 13 to 15 or entered a key that can specify unique data for a data ID input field, a claim number input field, etc., that is shown in the lower portion in the figure, and clicked on the “GO” button and the WEB server 101 received a signal indicating the targeted data was selected (S906). At this time, the display pattern master table 700 of the database 111 is examined using the subscriber account as a key to identify a display pattern and screen images for the subscriber account that are to be displayed on the itemized cabinet screen 304 (S907). For example, referring to FIGS. 5 and 7, if the login user is “user01”, the subscriber account is determined to be “account01”, pattern1 (not shown) is selected as a display pattern, and all the screen images 1 to 4 are to be displayed on the itemized cabinet screen 304.

Then, a decision is made on whether screen images to be displayed on the itemized cabinet screen 304 are present in the screen image storage unit 104 (S908). If it is determined at S908 that the screen images to be displayed on the itemized cabinet screen 304 are present in the screen image storage unit 104, the WEB screen creation unit 103 provides a targeted link for the screen images to be displayed, so that the itemized cabinet screen 304 presenting the screen images is displayed as shown in FIG. 16 (S910). Here, an image titled “Claim Data” in FIG. 16 is an itemized data display screen image, an image titled “History” is a history display screen image, an image titled “Attachment” is an attached file display screen image, and an image titled “Debit Note” is an insurance claim form issuance history display screen image.

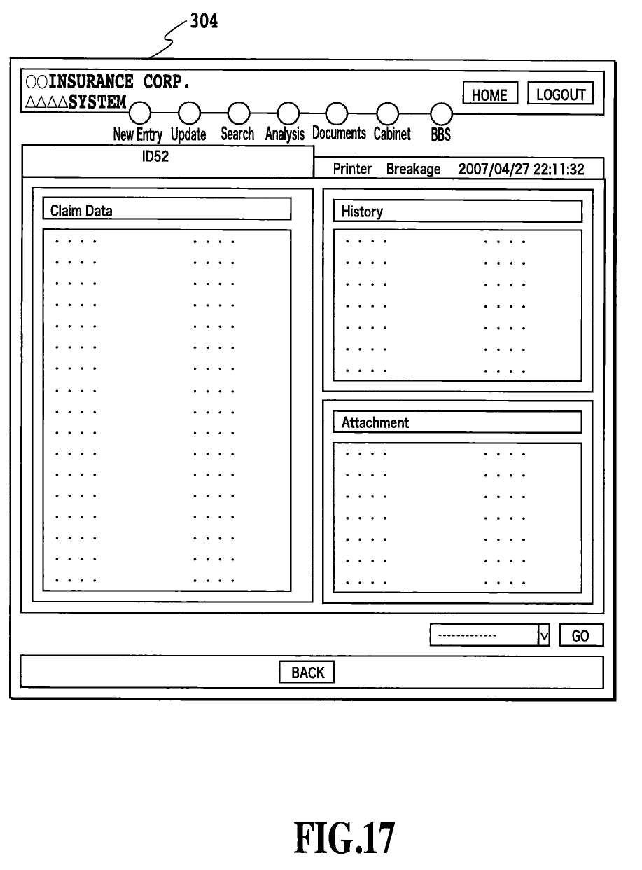

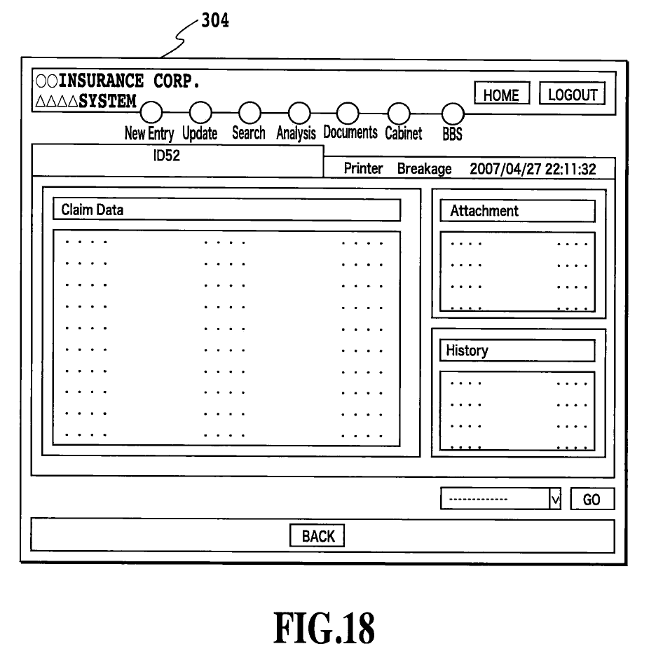

As described above, the itemized cabinet screen 304 can be changed in accordance with the values of the display pattern fields, the screen image 1, the screen image 2, the screen image 3 and the screen image 4 fields, in the display pattern master table 700, which is setup for each subscriber account. For example, the four screen images are arranged in a 2×2 matrix shape on the itemized cabinet screen 304 in FIG. 16. Further, three screen images, excluding the insurance claim form issuance history display screen image, are arranged on the itemized cabinet screen 304 in FIG. 17. In this screen, the itemized data display screen image is displayed on the left half of the screen, so that the user can view more information, and the history display screen image and the equally sized attached file display screen image are displayed at the top and the bottom of the right half of the screen. Also, three screen images, excluding the insurance claim form issuance history display screen image, are arranged on the itemized cabinet screen 304 as shown in FIG. 18. In this screen, the itemized data display screen image is displayed on the left of the screen so as to occupy half or more of the screen area in the transverse direction so that part of the information on the itemized data display screen can be viewed in detail, and the history display screen image and the equally sized attached file display screen images, are displayed at the top and bottom of the remaining screen area which are smaller than the display area in FIG. 17.

On the other hand, since the image acquisition batch processing is performed every predetermined period of time, screen images to be displayed on the itemized cabinet screen 304 may not be present in the screen image storage unit 104. Therefore, if it is determined at S908 that screen images to be displayed on the itemized cabinet screen 304 are not present in the screen image storage unit 104, the processing continues to S909 and the cabinet screen image creation unit 105 creates a screen image. The screen image creation processing at S909 will now be described with reference to FIG. 10.

FIG. 10 is a flowchart showing the processing performed by the cabinet screen image creation unit 105 of the visual cabinet system 100 according to this embodiment.

First, since each HTML file is described for each URLs including data IDs in the image acquisition site 107, the URL of the image acquisition site 107 is identified based on a data identification number (data ID) received at S906 in FIG. 9 (S1001).

Then, the image acquisition site 107 is logged in, and the URL identified by the targeted data identification number (data ID) is accessed, and regardless of whether or not data are to be presented to a user, the HTML file for all the HTML screens (four in this embodiment) related to the pertinent data is described by the WEB screen creation unit 309 (S1002). For the login to the image acquisition site 107, authentication is performed for security purposes. However, since an ID and a password required for the authentication have been setup for a program that performs this processing, disapproval of the login does not occur.

Then, well known capture software is employed to create screen image files (gif files in this embodiment) for the individual HTML screens described in HTML file at S1002 (S1003). The file name of each screen image file is uniquely determined based on a subscriber account name, a data identification number (data ID) and a screen number. Thereafter, the created screen image files are stored in the individual subscriber account folders (directories) of the screen image storage unit 104 (S1004), and the processing continues to S910 in FIG. 9.

Through this processing, the itemized cabinet screen 304 shown in FIG. 16, for example, is displayed on the output screen of the user terminal. In FIG. 16, four screen images corresponding to the latest available data are displayed. When one of these screen images is clicked on, that screen image transits to one of the itemized data display screen 305, the history display screen 306, the attached file display screen 307, and the insurance claim form issuance history display screen 308, all of which are created by the WEB screen creation unit 103.

As an example, when “Attachment” is clicked on in the itemized cabinet screen 304 in FIG. 16, the attached file display screen 307 shown in FIG. 17 is displayed.

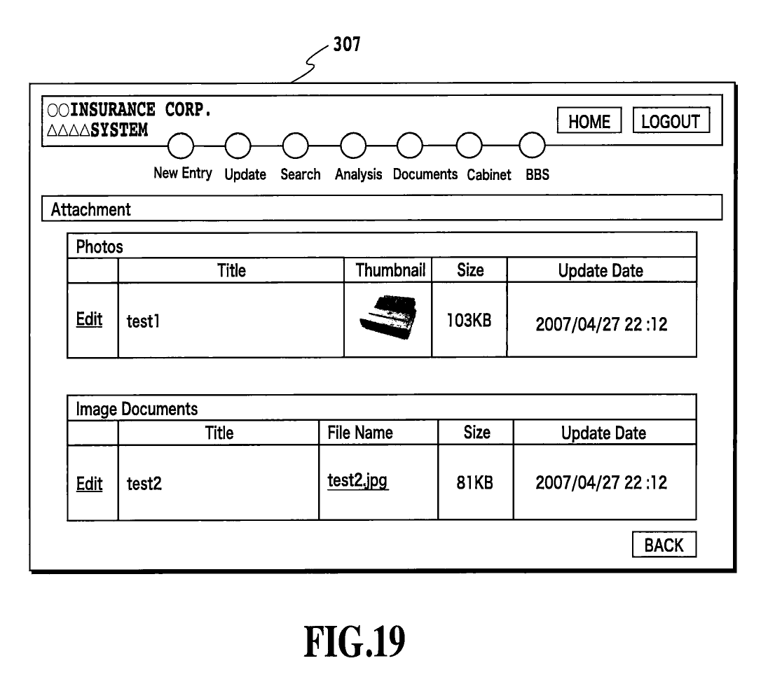

Further, when an arbitrary item is selected on a pull-down menu in the lower right of the itemized cabinet screen 304 in FIG. 16 and the “GO” button is clicked on, the screen transits to the screen that is created by the WEB screen creation unit 103, and corresponds to the selected item. For example, if “Debit Note” is selected on the pull-down menu on the itemized cabinet screen 304 in FIG. 18, and the “Go” button is clicked on, the insurance claim form issuance history display screen 308 shown in FIG. 19 is displayed.

In this embodiment, the screen image created in the image acquisition site 107 includes all the data entries that are displayed on the original screen. However, as another embodiment, a database table may be provided that includes a flag field indicating that a plurality of data items for screens should or should not be displayed on the individual screens for each subscriber account, and the image acquisition site 107 may generate the screen images in accordance with the display/non-display state.

As described above, according to the present invention, an itemized outline of data contents can be comprehended visually on the Internet so that the data contents can be confirmed in detail immediately. Furthermore, according to the present invention, screen images stored based on the user types can be displayed in accordance with the types and the layouts that correspond to the needs of individual users.

1. A visual data cabinet system comprising a WEB server which includes a user browsing site accessible from a user terminal via the Internet, and a database server, characterized in that
the database server includes:
a user master table having a user ID, a password and a subscriber account for a user permitted to access the user browsing site via the Internet; and
a data table having a data set which includes a data ID associated with the subscriber account;
the WEB server includes:
an image acquisition site which is a mirror site for the user browsing site; and
a screen image batch processor for accessing the data table every predetermined period of time, and if new data and updated data are present in the data table, requesting the image acquisition site to create one or more HTML screens associated with all of the new and the updated data and obtaining images of the one or more HTML screens;
the user browsing site includes
a user authentication unit for comparing a user ID and a password that are received from the user terminal via the Internet with the user ID and the password stored in the user master table, and for determining whether access to the user browsing site may be approved,
a screen image storage unit for storing images for the one or more HTML screens obtained by the screen image batch processor, and
a WEB screen creation unit for, when the authenticated user terminal requests to display a predetermined HTML screen associated with the subscriber account and one of data IDs included in the data table, creating the predetermined HTML screen by providing a link for transition to an HTML screen or screens corresponding to the image of one or more HTML screens for an image of the one or more screens associated with the subscriber account and the data ID and stored in the screen image storage unit; and
wherein the one or more HTML screens displays the latest information associated with the subscriber account and the data ID.

2. The visual data cabinet system according to claim 1, characterized in that the user browsing site further includes:
a screen image creation unit for, when the authenticated user terminal requested to display the predetermined HTML screen and, when the image of the one or more HTML screens associated with the subscriber account and the data ID have not been stored in the screen image storage unit, requesting the image acquisition site to acquire the one or more HTML screens associated with the subscriber account and the data ID and to store the image for the one or more HTML screens in the screen image storage unit.

3. The visual data cabinet system according to claim 1 or 2, characterized in that the database server further comprises a display pattern master table that includes, for each subscriber account,
information related to whether the image for the one or more HTML screens, obtained by the screen image batch processor, should be displayed on the predetermined HTML screen, and
a template which defines layouts for the image of the one or more HTML screens.

4. A data display method employing a visual data cabinet system that includes: a WEB server which includes a user browsing site that can be accessed from a user terminal via the Internet, a screen acquisition site that is a mirror site for the user browsing site, and a screen image batch processor; and a database server which includes a user master table having a user ID, a password and a subscriber account for a user permitted to access to the user browsing site via the Internet, and a data table having a data set which includes a data ID, in association with the subscriber account, the user browsing site including a screen image storage unit and a WEB screen creation unit, characterized in that:
the screen image batch processor accesses the data table every predetermined period of time, and if new data and updated data are present in the data table, the screen image batch processor requests the image acquisition site to create one or more HTML screens associated with all the data, the new and the updated, and obtains images for the one or more HTML screens to be stored in the screen image storage unit;
the user authentication unit compares a user ID and a password that are received from the user terminal via the Internet with the user ID and the password stored in the user master table, and determines whether access to the user browsing site may be approved; and
when the authenticated user terminal requests to display a predetermined HTML screen associated with the subscriber account and one of data IDs included in the data table, the WEB screen creation unit creates the predetermined HTML screen by providing a link for transition to an HTML screen or screens corresponding to the image of one or more HTML screens for an image of the one or more screens that are associated with the subscriber account and the data ID and stored in the screen image storage unit.

5. The data display method according to claim 4, characterized in that:
the user browsing site further includes a screen image creation unit; and
when the authenticated user terminal that requests to display the predetermined HTML screen and, when the image of the one or more HTML screens associated with the subscriber account and the data ID have not been stored in the screen image storage unit, the screen image creation unit requests the image acquisition site to acquire the one or more HTML screens associated with the subscriber account and the data ID and to store the image for the one or more HTML screens in the screen image storage unit.

6. The data display method according to claim 4 or 5, characterized in that:
the database server further has a display pattern master table that includes, for each subscriber account,
information on whether the image for the one or more HTML screens obtained by the screen image batch processor, should be displayed on the predetermined HTML screen, and
a template which defines layouts for the image of the one or more HTML screens.
